(19) United States
(12) Patent Application Publication
(10) Pub. No.: US 2026/0369761 A1
(43) Pub. Date: Nov. 19, 2026

(54) BATTERY CELL

(71) Applicant: TOYOTA JIDOSHA KABUSHIKI KAISHA, Toyota-shi (JP)

(72) Inventors: Atsushi SUGIHARA, Toyota-shi (JP); Satoshi NAKASHIMA, Toyota-shi (JP); Masato ONO, Nagoya-shi (JP); Masayoshi HAGA, Nagoya-shi (JP); Jun IZUMI, Toyota-shi (JP); Masahiro ISHIZUKA, Toyota-shi (JP); Kenta MIYAHARA, Toyota-shi (JP)

(73) Assignee: TOYOTA JIDOSHA KABUSHIKI KAISHA, Toyota-shi (JP)

(21) Appl. No.: 19/649,623

(22) Filed: Apr. 16, 2026

(30) Foreign Application Priority Data
May 16, 2025 (JP) 2025-082768

(51) Int. Cl. H01M 50/186; H01M 50/105; H01M 50/211

(52) U.S. Cl. CPC H01M 50/186; H01M 50/105; H01M 50/211

(57) ABSTRACT

A battery cell includes: a power storage element; and a film member wrapping the power storage element. The battery cell has a flat shape. A welding portion in which end portions of the film member are welded to each other is provided on a surface of the battery cell in a thickness direction. When a plurality of the battery cells is stacked to form a battery module, the battery module can be reduced in size.

### CROSS-REFERENCE TO RELATED APPLICATION

This application claims priority to Japanese Patent Application No. 2025-082768 filed on May 16, 2025. The disclosure of the above-identified application, including the specification, drawings, and claims, is incorporated by reference herein in its entirety.

### BACKGROUND

### 1. Technical Field

The technology disclosed in the present specification relates to a battery cell.

### 2. Description of Related Art

A battery cell disclosed in Japanese Unexamined Patent Application Publication No. 2020-68197 (JP 2020-68197 A) includes a power storage element and a film member wrapping the power storage element. End portions of the film member are welded to each other, and thus the film member is sealed. The battery cell has a flat shape. A welding portion of the film member is provided on a side surface of the battery cell.

### SUMMARY

In a case of using the battery cell, a plurality of battery cells may be stacked in a thickness direction to form a battery module. When a plurality of battery cells of JP 2020-68197 A is stacked, the welding portion of the film member protrudes from a side surface of the battery module, and the battery module is increased in size. The present specification proposes a structure of a battery cell capable of reducing a size of a battery module.

The battery cell disclosed in the present specification includes:
a power storage element; and
a film member wrapping the power storage element.

The battery cell has a flat shape.

A welding portion in which end portions of the film member are welded to each other is provided on a surface of the battery cell in a thickness direction.

In the battery cell, the welding portion is provided on a surface (that is, a surface intersecting the thickness direction) of the battery cell in the thickness direction. Therefore, when a plurality of the battery cells is stacked, other battery cells are stacked on an upper portion of the welding portion of a battery cell that is predetermined. Therefore, a portion in which the welding portion protrudes from the side surface of the battery module can be reduced as compared to the related art. Therefore, when the battery cell is used to form the battery module, the battery module can be reduced in size.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a battery cell;

FIG. 2 is a plan view of the battery cell as viewed along a z direction;

FIG. 3 is a cross-sectional view taken along line III-III of FIG. 2;

FIG. 4 is a cross-sectional view of a battery module in which battery cells of embodiments are stacked;

FIG. 5 is a cross-sectional view of a battery module in which battery cells of comparative embodiments are stacked; and

FIG. 6 is a view for describing a manufacturing method of the battery cell.

### DETAILED DESCRIPTION OF EMBODIMENTS

The following is a list of additional configurations disclosed in the present specification.

The welding portion may be disposed at a position shifted from a center line of the surface.

According to this configuration, when a plurality of battery cells is stacked, each battery cell is likely to be stable.

In the battery module having a structure in which the battery cells are stacked in the thickness direction, the following configuration may be adopted. The battery cells may include a first battery cell and a second battery cell stacked on the welding portion of the first battery cell.

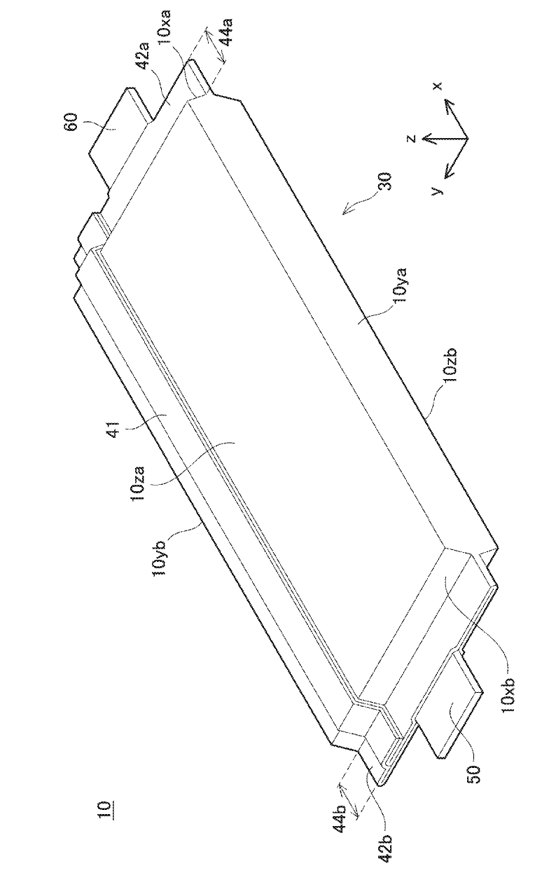

As shown in FIG. 1, a battery cell 10 of the embodiment has a rectangular flat shape that is long in an x direction. In the following, a thickness direction of the battery cell 10 is referred to as a z direction, a longitudinal direction of the battery cell 10 is referred to as an x direction, and a direction orthogonal to the z direction and the x direction is referred to as a y direction. In addition, in the following, a surface of the battery cell 10 that is exposed to one side in the z direction is referred to as a main surface 10za, and a surface of the battery cell 10 that is exposed to the other side in the z direction is referred to as a main surface 10zb. In addition, in the following, a surface of the battery cell 10 that is exposed to one side in the x direction is referred to as a side surface 10xa, and a surface of the battery cell 10 that is exposed to the other side in the x direction is referred to as a side surface 10xb. In addition, in the following, a surface of the battery cell 10 that is exposed to one side in the y direction is referred to as a side surface 10ya, and a surface of the battery cell 10 that is exposed to the other side in the y direction is referred to as a side surface 10yb. Areas of the main surfaces 10za and 10zb are larger than areas of the side surfaces 10ya and 10yb. Areas of the side surfaces 10ya and 10yb are larger than areas of the side surfaces 10xa and 10xb. In a case of using the battery cell 10, a plurality of battery cells 10 is stacked in the z direction to form a battery module.

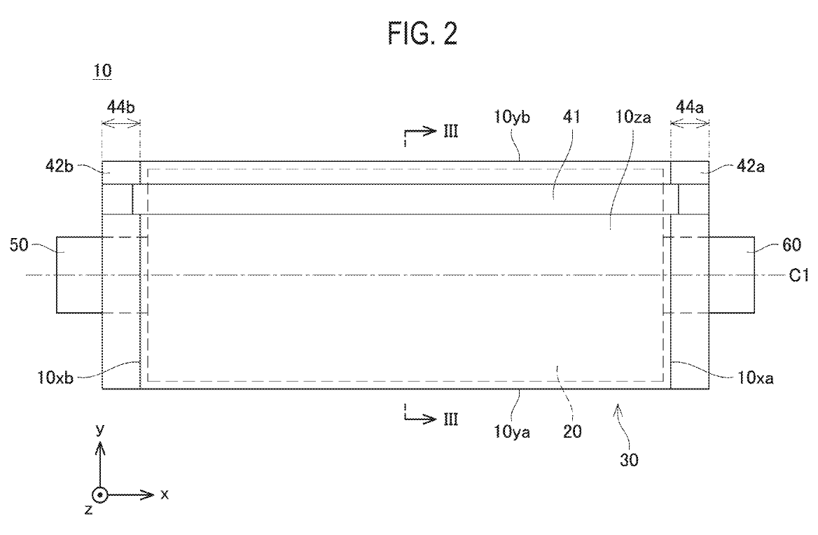

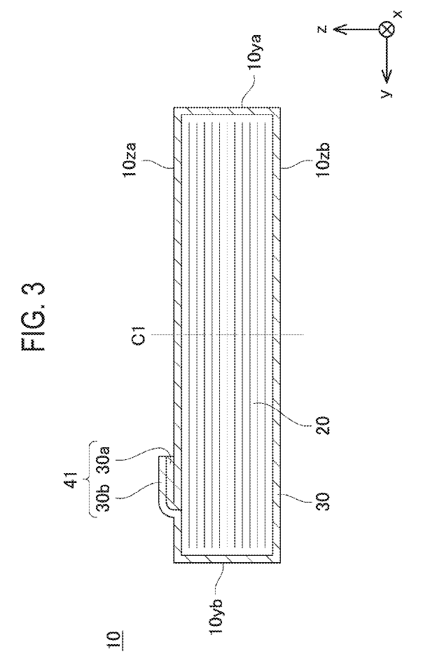

As shown in FIGS. 2 and 3, the battery cell 10 includes a power storage element 20 and a film member 30. The film member 30 wraps the power storage element 20. In other words, the power storage element 20 is accommodated inside the film member 30. The film member 30 accommodates an electrolytic solution together with the power storage element 20. The power storage element 20 is immersed in the electrolytic solution. Electrode plates 50 and 60 are provided at both end portions of the battery cell 10 in the x direction. The electrode plate 50 is a positive electrode of the battery cell 10, and the electrode plate 60 is a negative electrode of the battery cell 10.

The power storage element 20 is a chargeable and dischargeable battery element, and outputs a direct current voltage. The power storage element 20 has a rectangular flat shape. The power storage element 20 is a stack in which a plurality of positive electrode collector foils and negative electrode collector foils is stacked in the z direction in an alternating manner via a separator. The electrode plate 50 is connected to one end portion of the power storage element 20 in the x direction. The electrode plate 60 is connected to the other end portion of the power storage element 20 in the x direction.

As shown in FIG. 3, the film member 30 is a thin sheet-like member. The film member 30 is composed of an aluminum film and a resin film that covers both surfaces of the aluminum film. The film member 30 is bent to wrap the power storage element 20. A first welding portion 41 where one end portion 30a and the other end portion 30b of the film member 30 are welded to each other is provided on the main surface 10za of the battery cell 10. As shown in FIGS. 1 and 2, the first welding portion 41 extends from one end portion to the other end portion of the battery cell 10 along the longitudinal direction (that is, the x direction) of the battery cell 10. The first welding portion 41 is bent along the main surface 10za of the battery cell 10. A center line C1 of FIGS. 2 and 3 indicates a center in the y direction of the main surface 10za. The first welding portion 41 is provided at a position shifted in the y direction from the center line C1.

As shown in FIGS. 1 and 2, the film member 30 includes a surplus portion 44a that extends to an outer side of the side surface 10xa and a surplus portion 44b that extends to an outer side of the side surface 10xb. A second welding portion 42a where an upper portion and a lower portion of the film member 30 are welded to each other is provided in the surplus portion 44a. A second welding portion 42b where an upper portion and a lower portion of the film member 30 are welded to each other is provided in the surplus portion 44b. The upper portion of the film member 30 is a portion constituting the main surface 10za, and the lower portion of the film member 30 is a portion constituting the main surface 10zb. The second welding portion 42a protrudes from the side surface 10xa, and the second welding portion 42b protrudes from the side surface 10xb.

As shown in FIGS. 1 and 2, the electrode plates 50 and 60 extend from the power storage element 20 to the outer side of the film member 30. The electrode plate 60 extends from the inner side to the outer side of the film member 30 through an interface between the upper portion and the lower portion of the film member 30 in the second welding portion 42a. The electrode plate 50 extends from the inner side to the outer side of the film member 30 through the interface between the upper portion and the lower portion of the film member 30 in the second welding portion 42b. In a region where the electrode plates 50 and 60 are present, the upper portion of the film member 30 is welded to upper surfaces of the electrode plates 50 and 60, and the lower portion of the film member 30 is welded to lower surfaces of the electrode plates 50 and 60.

The film member 30 is sealed by welding the film member 30 at the first welding portion 41 and the second welding portions 42a and 42b.

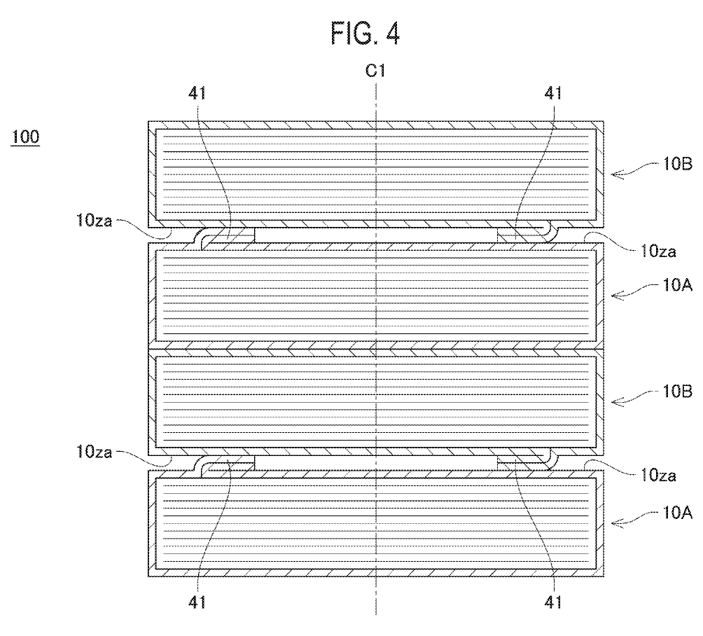

FIG. 4 shows a battery module 100 having a structure in which the battery cells 10 are stacked. In FIG. 4, the battery cell 10 in which the main surface 10za is disposed upward is shown as a battery cell 10A, and the battery cell 10 in which the main surface 10za is disposed downward is shown as a battery cell 10B. As shown in FIG. 4, the battery cell 10A and the battery cell 10B are alternately stacked. The battery cell 10B is stacked on the battery cell 10A such that the main surface 10za of the battery cell 10B faces the main surface 10za of the battery cell 10A. Therefore, the first welding portion 41 of the battery cell 10A and the first welding portion 41 of the battery cell 10B are sandwiched by body portions of the battery cells 10A and 10B.

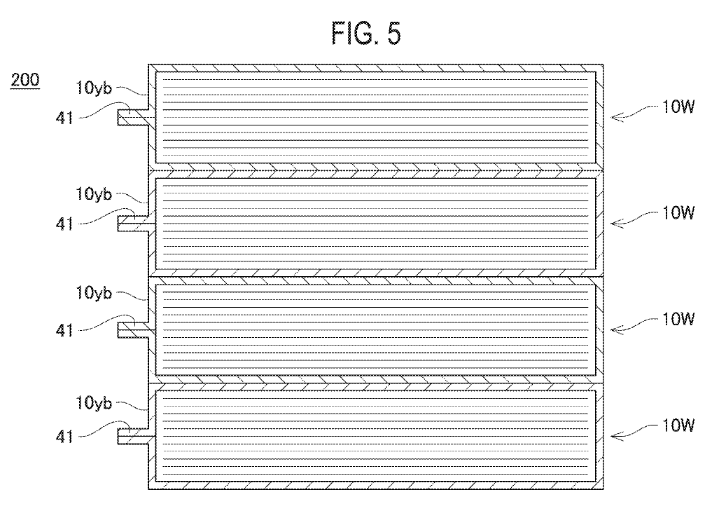

FIG. 5 shows a battery module 200 of the comparative embodiment. Each battery cell 10W constituting the battery module 200 of FIG. 5 has the first welding portion 41 on the side surface 10yb. The first welding portion 41 protrudes from the side surface 10yb. In the structure of FIG. 5, since the first welding portion 41 protrudes from the side surface 10yb in each battery cell 10W, a dimension of the battery module 200 in a width direction is increased. Therefore, when the battery module 200 is mounted on a device (for example, an electrified vehicle, or an electric device), a volume occupied by the battery module 200 is large. On the other hand, in the battery module 100 shown in FIG. 4, since the first welding portion 41 is not present on the side surface 10yb, the dimension of the battery module 100 in the width direction is small. In addition, since the first welding portion 41 is bent along the main surface 10za, the dimension of the battery module 100 in the stacking direction is not so large. Therefore, according to the structure of the embodiment shown in FIG. 4, the volume occupied by the battery module can be reduced as compared with the structure of the comparative embodiment shown in FIG. 5, and the battery module can be reduced in size. Therefore, in the battery module 100 of the embodiment, a power that can be stored per unit volume is large.

In addition, in the structure of the embodiment shown in FIG. 4, since the first welding portion 41 functions as a buffer member in a case of stacking the battery cell 10, the battery cell 10 can be stably stacked. In addition, the first welding portion 41 of the battery cell 10A is disposed on a side opposite to the first welding portion 41 of the battery cell 10B via the center line C1. Therefore, the battery cell 10B can be stably stacked on the battery cell 10A.

In addition, in the structure of the embodiment shown in FIG. 4, since the first welding portion 41 is sandwiched by the body portions of the battery cells 10A and 10B, water is unlikely to enter the first welding portion 41. In addition, in the structure of FIG. 4, even when a width of the first welding portion 41 is increased, a size of the battery module is not increased. Therefore, the width of the first welding portion 41 can be increased to lengthen a path for moisture to enter the battery cell 10. As described above, according to the structure of the embodiment shown in FIG. 4, a risk of moisture entering the battery cell 10 can be reduced.

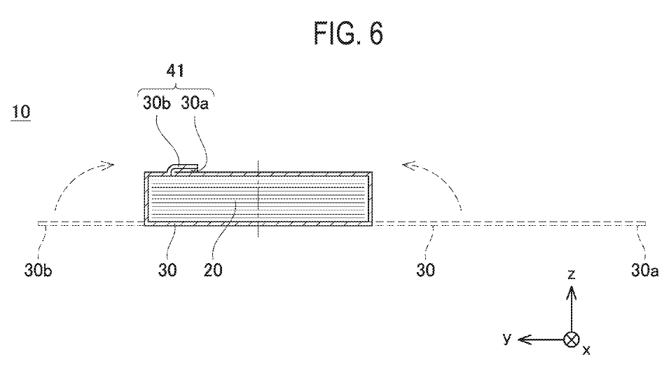

Next, a manufacturing method of the battery cell 10 will be described. First, as shown by a broken line in FIG. 6, a planar film member 30 is prepared. Next, as shown by an arrow in FIG. 6, the film member 30 is bent along the x-axis to wrap the power storage element 20 with the film member 30. Next, the end portions 30a and 30b of the film member 30 are welded in a state of wrapping the power storage element 20 to form the first welding portion 41. Instead of the step of FIG. 6, the end portions 30a and 30b of the film member 30 may be welded in advance, and the power storage element 20 may be disposed inside the film member 30 having a tubular shape. Next, the upper portion and the lower portion of the film member 30 are welded in the surplus portions 44a and 44b of the film member 30 to form the second welding portions 42a and 42b as shown in FIGS. 1 and 2. As a result, the film member 30 is sealed, and the battery cell 10 is completed. With the manufacturing method, since the embossing processing of forming the film member 30 into a container shape is not needed, the battery cell 10 can be manufactured more efficiently than in the related art.

Although the embodiment has been described in detail above, these are merely examples and do not limit the scope of the claims. The techniques described in the claims include various modifications and changes of the specific examples exemplified above. The technical elements described in the present specification or the drawings exhibit technical usefulness alone or in various combinations, and are not limited to the combinations described in the claims at the time of filing. Further, the techniques exemplified in the present specification or the drawings achieve a plurality of objectives at the same time, and achieving one of the objectives itself has technical usefulness.

What is claimed is:

1. A battery cell comprising:
a power storage element; and
a film member wrapping the power storage element, wherein:
the battery cell has a flat shape; and
a welding portion in which end portions of the film member are welded to each other is provided on a surface of the battery cell in a thickness direction.

2. The battery cell according to claim 1, wherein the welding portion is disposed at a position shifted from a center line of the surface.

3. A battery module comprising a structure in which a plurality of the battery cells according to claim 1 is stacked in the thickness direction,
wherein the battery cells include a first battery cell and a second battery cell stacked on the welding portion of the first battery cell.
